(19) United States
(12) Patent Application Publication
(10) Pub. No.: US 2015/0382110 A9
(43) Pub. Date: Dec. 31, 2015

(54) Acoustic Transducer and Method for Driving Same

(71) Applicant: Lewis Athanas, Marblehead, MA (US)

(72) Inventor: Lewis Athanas, Marblehead, MA (US)

(21) Appl. No.: 14/214,585

(22) Filed: Mar. 14, 2014

Related U.S. Application Data
(60) Provisional application No. 61/802,289, filed on Mar. 15, 2013.
(60) Provisional application No. 61/785,918, filed on Mar. 14, 2013.

(51) Int. Cl. H04R 7/02; H04R 1/00

(52) U.S. Cl. CPC H04R 7/02; H04R 1/00

(57) ABSTRACT

An acoustic transducer and method for driving same. A flat or somewhat curved panel has one or more drive motors at selected locations to generate transverse waves in the panel and concomitant longitudinal acoustic waves in an acoustic medium in which the panel is disposed. It also has attenuation features, such as damping or active wave cancellation motors, at one or more boundaries to substantially attenuate or essentially cancel arriving transverse waves and the reflections they would otherwise produce, thereby creating virtual infinite panel boundaries and reducing or substantially eliminating unwanted modes and wave interference in the panel. A linear motor is provided for driving one or more edges of the panel.

### CROSS REFERENCE TO RELATED APPLICATIONS

Applicant claims priority to U.S. Provisional Application No. 61/785,918, filed Mar. 14, 2013 and entitled “Loudspeaker With Synthesized Wavefront Output,” and to U.S. Provisional Application No. 61/802,289, filed Mar. 14, 2013 and entitled “Linear Loudspeaker Motor,” the entire contents of both of which are hereby incorporated into the present patent application by reference.

### FIELD OF THE INVENTION

The invention disclosed herein relates to acoustic transducers employing a diaphragm that produces an acoustic longitudinal wave propagating away from the diaphragm in an acoustic medium as a result of generating a transverse acoustic wave in the diaphragm, and particularly to flat or curved panel loudspeakers.

### BACKGROUND

There are various applications for which a loudspeaker that has a flat, or slightly curved, sound producing diaphragm. This is particularly so where the diaphragm, or the projection of a curved diaphragm on a plane, is a rectangle. Such loudspeakers can facilitate thinner, less bulky designs having less spatial volume than traditional dynamic (cone) loudspeakers. If the diaphragm is constructed from a suitable glass or plastic, the speaker may be transparent so that it can be placed over a video display or other light source, allowing very compact audio/visual product designs with many attractive attributes, such as improved audio/visual experience, reduced space needs for the product, and design creativity not allowed by tradition audio/visual technologies.

Traditional dynamic loudspeakers comprise a motor attached to a cone shaped diaphragm. The cone shape gives the diaphragm the stiffness needed to retain its shape under the excursions and velocities needed to act as an acoustic air pump. As the cone angle is flattened, the cone is more likely to take on undesirable vibrational modes called variously, for example, breakup, chaotic or uncontrolled behavior, or buckling. If the cone angle is reduced to zero, that is, if the diaphragm is essentially flat, then in response to a traditional motor pushing and pulling on the diaphragm much if not most of the diaphragm surface will break up into incoherent modes that reduce acoustic efficiency and produce distorted acoustic waveforms that do not faithfully reproduce sound.

However, various prior flat and curved panel technologies, particularly flat panel designs with an open and transparent middle section, have had various undesirable performance characteristics as a result of distributed and changing undesirable vibration modes and acoustic interference patterns caused by reflections of transverse acoustic waves at the panel boundaries.

In addition, a traditional mechanism for driving a loudspeaker diaphragm has been be a motor that converts electrical energy, in the form of an electrical current signal representing an audio sound to be reproduced, into mechanical energy, in the form of a moving diaphragm that directly produces local changes in air pressure that propagate away from the diaphragm as longitudinal acoustic waves. The motor typically comprises a hollow cylindrical member having an electrical conductor wound around its periphery, the hollow cylindrical member being attached at one end to the speaker diaphragm and being disposed over a fixed, solid, cylindrical and typically permanent, magnet. When a current is caused to flow through the conductor, the magnetic field produced thereby interacts with the magnetic field of the fixed magnet to exert force on the hollow cylindrical member and thereby move the diaphragm to which that member is attached. This is known as a moving coil motor.

Accordingly, there has been a need for a type of acoustic transducer that can be the basis for a flat, or slightly curved, loudspeaker design that does not exhibit the foregoing undesirable, sound distorting characteristics, particularly for a type of transducer that can employ a transparent diaphragm without loss of audio fidelity.

Loudspeakers typically comprise a diaphragm driven by a circular moving coil. This driver, or motor, technology has been perfected over many decades. Reasons for the dominance this type of motor technology in the loudspeaker marketplace include efficiency, concise design based on the circular coil of wire in a magnetic gap, and that it is particularly suitable for cone and dome diaphragms.

However, as sound systems have become more miniaturized and embedded in products other than stand-alone music players, such as video and television products, a need for different form factors has arisen. Also, as speaker components have become smaller, this three dimensional source of acoustic radiation has effectively become a point source. Consequently, it is common now to see multiple small loudspeakers arranged in a line to approximate a line source. This requires much expense and complexity of design.

Accordingly, there is also a need for a more suitable, linear speaker motor in many applications. For example, such a motor can make possible many attractive loudspeaker, and combination video and loudspeaker, designs from both an acoustic and industrial design point of view. Indeed, a linear motor may be integrated with an amplifier and ancillary electronics to expand such design possibilities.

### SUMMARY

An acoustic transducer is disclosed, comprising a diaphragm having at least one boundary; at least one wave generator coupled to the diaphragm at a corresponding location on the diaphragm to displace the diaphragm and thereby produce a transverse wave in the diaphragm that propagates away from that location toward said at least one boundary; and at least one attenuator coupled to the diaphragm at a corresponding location on said at least one boundary of the diaphragm to substantially attenuate the transverse wave at that location, thereby substantially preventing the production of a reflected transverse wave from that boundary location, such that when the transducer is disposed in an acoustic medium and the wave generator displaces the diaphragm, the transverse wave produced in the diaphragm produces an acoustic longitudinal wave in the medium propagating away from the diaphragm with substantially attenuated distortion from interfering diaphragm transverse waves reflected from that boundary location.

A method is disclosed for driving an acoustic transducer having a diaphragm with at least one boundary, comprising displacing the diaphragm at a selected location onto the diaphragm, thereby producing a transverse wave in the diaphragm that propagates away from that location toward said at least one boundary; and substantially attenuating the transverse wave at least at one location on the boundary to substantially prevent the production of a reflected transverse wave from that boundary location, such that when the transducer is disposed in an acoustic medium and the wave generator displaces the diaphragm, the transverse wave produced in the diaphragm produces an acoustic longitudinal wave in the medium propagating away from the diaphragm with substantially attenuated distortion from interfering diaphragm transverse waves reflected from that boundary location.

A motor is disclosed for producing planar motion, comprising an elongate first magnet having north and south poles extending along the elongate dimension of the first magnet; an elongate second elongate magnet having a north and south poles extending along the elongate dimension of the second magnet; a support member for holding the first magnet in relation to the second magnet so that their elongate dimensions are substantially parallel, opposite poles of the first magnet and the second magnet face one another, respectively, and a gap exists there between; and a substantially planar armature disposed in the gap between the first magnet and the second magnet, the armature having a driving portion adjacent one edge thereof and a flat, electrically-conductive element having an elongate dimension extending substantially parallel to the elongate axes of the magnets, such that when an electric current is caused to flow in the elongate dimension of the electrically-conductive element, a force is exerted on the planar armature in a translational direction parallel to a surface of the armature and perpendicular to the elongate axes of the magnets.

A method for producing motion in a plane, comprising providing a U-shaped magnet having two sides separated by an elongate gap, having a north pole on one side the gap and a south pole on the other side of the gap; supporting an elongate substantially flat, rigid and movable armature within the gap; providing an elongate electrically-conductive strip disposed on the armature extending in the elongate dimension of the gap; and causing an electric current to flow in the strip so as to produce a magnetic field and concomitant force on the armature tending to move it in or out of the gap.

It is to be understood that this summary is provided as a means for generally determining what follows in the drawings and detailed description, and is not intended to limit the scope of the invention. The foregoing and other objects, features, and advantages of the invention will be readily understood upon consideration of the following detailed description taken in conjunction with the accompanying drawings.

### BRIEF DESCRIPTION OF THE DRAWINGS

FIG. 1 is a side view of an idealized acoustic transducer having a diaphragm with finite edge dimensions and a central drive motor, illustrating its motion in response to an electrical input signal.

FIG. 2 is a side view of an a real acoustic transducer having a diaphragm with finite edge dimensions and a central drive motor, illustrating its motion in response to an electrical input signal.

FIG. 3 is an illustration of an idealized acoustic transducer having a diaphragm with infinite edge dimensions and a central drive motor, illustrating its motion in response to a low-frequency electrical input signal.

FIG. 4 is an illustration of an idealized acoustic transducer having a diaphragm with infinite edge dimensions and a central drive motor, illustrating its motion in response to a high-frequency electrical input signal.

FIG. 5 is a perspective of a rectangular acoustic transducer having a quiescently flat diaphragm, wherein linear transverse diaphragm waves have been generated at the left edge and propagated toward the right edge, and a first one has been reflected back.

FIG. 6 is side view of a rectangular acoustic transducer having a quiescently flat rectangular diaphragm in an acoustic medium, a wave generation motor coupled to the left edge of the diaphragm, and a constant pressure line adjacent the diaphragm.

FIG. 7 is a side view of the acoustic transducer of FIG. 6 illustrating displacement of the left edge of the diaphragm by the motor to generate a transverse diaphragm wave propagating toward the right edge of the diaphragm.

FIG. 8 is side view of the acoustic transducer of FIG. 6 illustrating that the transverse diaphragm wave generates a longitudinal wave in the acoustic medium as the transverse wave propagates toward the right edge of the diaphragm.

FIG. 9 is a side view of the acoustic transducer of FIG. 6 just as the transverse wave of FIG. 8 reaches the right edge of the diaphragm.

FIG. 10 is a side view of the acoustic transducer of FIG. 6, illustrating that when a transverse wave propagating from the left edge encounters the fixed right edge of the diaphragm, it is reflected back toward the left edge of the diaphragm and produces a new longitudinal wave in the medium.

FIG. 11 is a side view of the acoustic transducer of FIG. 6 having an idealized damping device coupled to the right edge of the diaphragm, illustrating how a damping material prevents reflection by absorbing the arriving wave energy.

FIG. 12 is a perspective of a suitable damping element to be placed at a diaphragm edge to absorb arriving wave energy.

FIG. 13 is a side view of an acoustic transducer having a quiescently flat rectangular diaphragm in an acoustic medium, a wave generation motor coupled to the left edge of the diaphragm, and an idealized wave cancellation motor coupled to the right edge of the diaphragm, illustrating how the right edge of the diaphragm would move in response to an arriving transverse wave in the absence of a cancellation signal applied to the cancellation motor.

FIG. 14 is a side view of an acoustic transducer having a quiescently flat rectangular diaphragm in an acoustic medium, a wave generation motor coupled to the left edge of the diaphragm, and an idealized wave cancellation motor coupled to the right edge of the diaphragm, illustrating that the right edge of the diaphragm would not move in response to an arriving transverse wave upon application of a cancellation signal to the cancellation motor.

FIG. 15 is a perspective of a quiescently flat rectangular diaphragm, illustrating displacement of the left edge of the diaphragm by a square wave and the effects of the characteristic frequency response, phase velocity and propagation dispersion of the diaphragm.

FIG. 16 shows a flat panel stereo loudspeaker according to the acoustic transducer principles=disclosed herein, including a schematic diagram of electronic drive circuitry, the loudspeaker having a single, quiescently flat rectangular diaphragm and multiple combined wave generation and wave attenuation motors disposed at left and right edges of the diaphragm.

FIG. 17 shows an embodiment of a flat panel stereo loudspeaker together with support structure, wherein the quiescently flat transducer diaphragm is transparent.

FIG. 18 is a top view of a circular acoustic transducer having a quiescently flat diaphragm, a wave generation motor, a plurality of wave cancellation motors and a plurality of damping members.

FIG. 19 is a side section of the acoustic transducer of FIG. 18.

FIG. 20 shows a flat panel loudspeaker according to the novel acoustic transducer principles disclosed herein, including a schematic diagram of electronic drive circuitry, the loudspeaker having a single rectangular diaphragm and multiple combined wave generation and wave attenuation motors disposed along all edges of the diaphragm.

FIG. 21 is an illustration of the use of the flat panel loudspeaker of FIG. 18 to produce a virtual longitudinal acoustic point source.

FIG. 22 is a perspective of a first embodiment of a linear transducer motor according to principles disclosed herein, attached to a flat panel acoustic transducer diaphragm.

FIG. 23 is a cross section of a second embodiment of a linear transducer motor according to the principles disclosed herein.

FIG. 24 is a cross section of a third embodiment of a linear transducer motor according to the principles disclosed herein.

FIG. 25 is a cross section of a fourth embodiment of a linear transducer motor according to the principles disclosed herein.

### DETAILED DESCRIPTION

1. Context

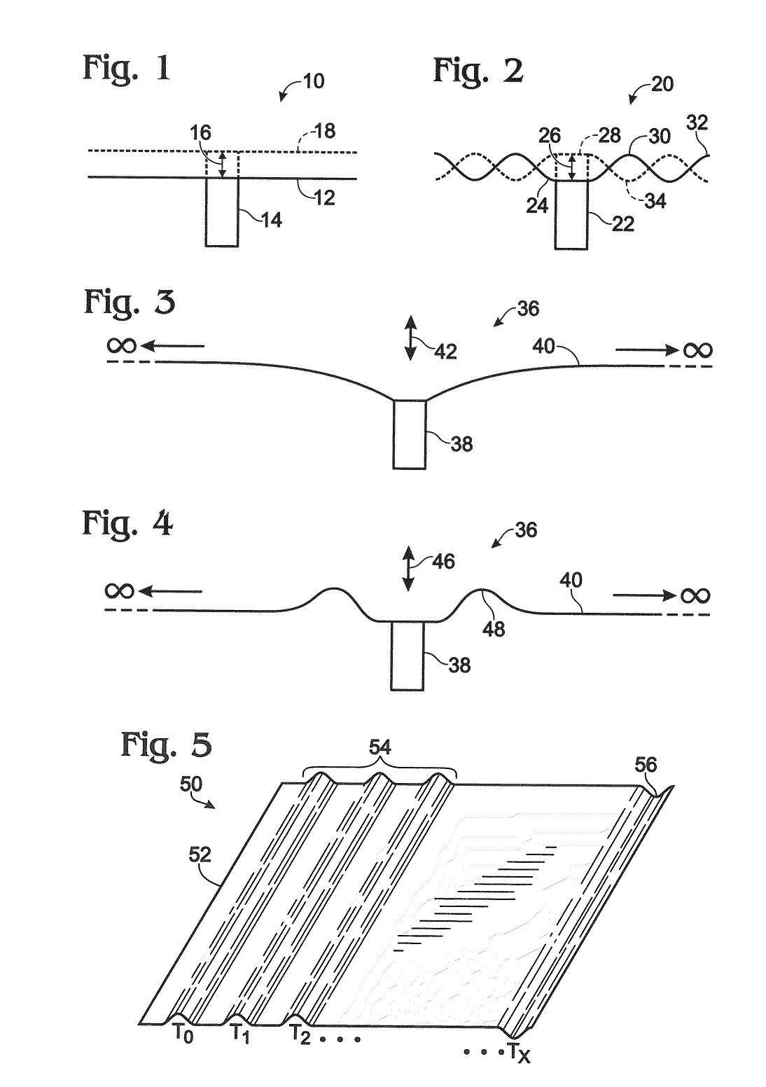

As shown in FIG. 1, an idealized acoustic transducer 10 is represented by a perfectly stiff circular diaphragm 12 and a perfect motor 14 coupled to the diaphragm to move the diaphragm up and down in proportion to an electric current through the motor. Because the diaphragm is perfectly stiff, the transverse speed of sound is instantaneous; that is, any displacement of the center of the diaphragm by the motor, indicated by arrow 16, will produce an instantaneous, identical response at the periphery of the diaphragm, shown by the dashed representation of the diaphragm 18. When disposed in an acoustic medium, such as air, the diaphragm produces local pressure variations in the medium which produces longitudinal waves in the medium that propagate away from the transducer, subject to edge effects due to the finite dimensions of the diaphragm. This could, for example, represent an audio frequency loudspeaker of finite dimension, but could also represent devices for other frequency bands and acoustic media other than air. For the purpose of further discussion, it will be assumed that the medium is air and the transducer is an audio loudspeaker, unless otherwise stated.

However, no real material is perfectly stiff, which leads to diaphragm resonance modes and other acoustic interference patterns due to reflections of transverse diaphragm waves from the diaphragm boundaries. FIG. 2 illustrates an acoustic transducer 20 having a motor 22 and a real circular diaphragm 24 that is not perfectly stiff. This means that it takes a finite time delay for a displacement caused by the motor, as indicated by arrow 26, at the center of the diagram to reach the edge of the diaphragm. This also means that the motor also does not have direct control over the entire diaphragm. How that portion of the diaphragm not directly connected to the motor responds to excitation by the motor depends on the distribution of mass and compliance (stiffness) of the diaphragm, as well as the size and boundary conditions of the diaphragm.

In FIG. 2 it can be seen that in response to the displacement of the center of the diaphragm 28 a transverse diaphragm wave 30 propagates outwardly to the edge 32 of the diaphragm. If this were all that occurred, then an essentially undistorted longitudinal spherical wave would be produced in the air. However, when the transverse diaphragm wave meets the diaphragm boundary 32, a reflected wave 34 propagates back toward the center of the diaphragm. This will at least produce interference with subsequent waves generated by the motor 22 and propagating outwardly, which will distort the transverse wave produced in the air by the diaphragm. But, in addition, at some frequency, or frequencies, depending on the transducer design one or more standing waves, or modal resonances will occur, as shown in FIG. 2. These phenomena are undesirable because they distort and thereby reduce the fidelity of the sound, but particularly because standing wave resonances produce audibly annoying excessive energy at particular frequencies and non-linear effects resulting in higher order distortion of the diaphragm and the sound produced thereby. Such modal behavior and interference distortion of the diaphragm depend on the boundary conditions of the diaphragm, that is, the extent which reflections of transverse waves can occur at boundaries of the diaphragm.

Turning now to FIG. 3, in a transducer 36, having motor 38 and a diaphragm 40 that is real in the sense that it is not perfectly stiff, but ideal in the sense that it extends to infinity, reflections cannot occur. With no boundaries to reflect the energy back, no standing waves or other interference can occur; the displacement of the diaphragm, represented by arrow 42, simply stretches to infinity over time, as indicated by curve 44. As shown in FIG. 4, at sufficiently high motor displacement frequencies, indicated by arrow 46, the movement of the diaphragm resembles a pebble dropped onto a still pond, with one or more rings 48 emanating from the point of excitation.

Among other things, this disclosure describes a flat panel, or diaphragm, loudspeaker. The term “quiescently” may be used herein to account for the fact that even though the panel, or diaphragm, is created to be “flat” within reasonable tolerances when it is at rest, when transverse waves are propagating through the panel its surface condition will be “wavy” rather than flat.

The application of the foregoing principles to a flat panel loudspeaker element 50 is shown in FIG. 5. In this case, the left hand edge 52 of the panel is displaced repeatedly to produce a sequence of transverse waves 54 that will require times T₀, T₁, T₂ and so forth to Tₓ to reach the right hand edge of the panel. Whether the right hand edge is free to move or is restrained so that it cannot move, as assumed in this case, a reflected wave will be produced that will propagate back to the left hand edge, and so forth as discussed above with respect to a circular diaphragm of finite extent displaced by a centrally-located motor.

2. The Advancements

The advancements described herein serve to provide a real acoustic transducer with a diaphragm having virtually infinite boundaries, thereby eliminating modal and other phenomena otherwise resulting from interference of waves reflected from the real boundary, or boundaries, of the diaphragm. Because these advancements are particularly useful for flat panel loudspeakers, the advancements are explained primarily in that context in this disclosure. However, this disclosure is not intended to exclude application of the principles described herein to other types of moving diaphragm acoustic transducers.

a. Acoustic Transducer

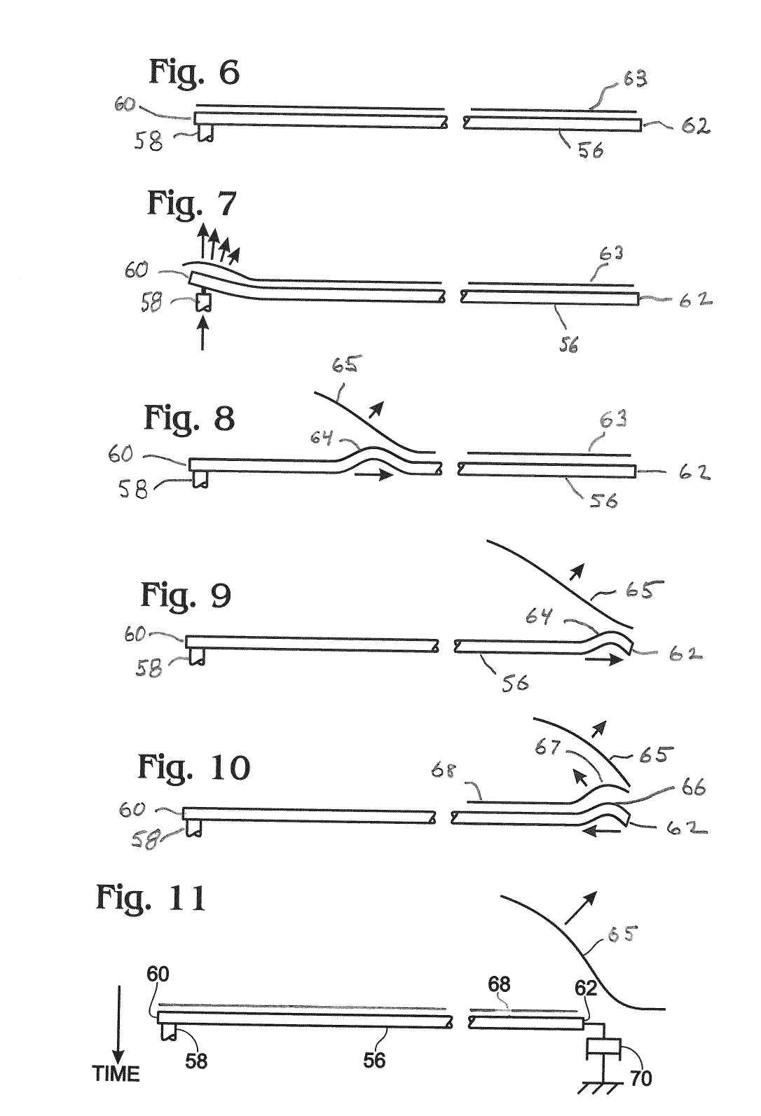

Side edge views of the generation and propagation of a transverse wave across a flat, rectangular panel 56 having a motor 58 at the left hand edge 60 and being unconstrained at the right hand edge 62, and the resulting generation of longitudinal waves in the air surrounding the panel, are shown in FIGS. 6 through 10. In FIG. 6 the panel is quiescent. Line 63 represents a constant pressure contour line in the air adjacent the top surface of the panel.

In FIG. 7 motor 58 displaces the left hand edge of the panel 56 upwardly, thereby generating a transverse wave moving to the right in the panel, compressing the adjacent air and moving the constant pressure line up and to the right, and generating a longitudinal wave 65 in the air. In FIG. 8 the transverse wave 64 has moved part way across the panel 56 and the longitudinal wave 65 in the air has propagated to the position shown by the pressure contour line 63. In FIG. 9 the transverse wave 64 has reached the unrestrained right hand edge 62 of the panel 56, which will be caused to move up, then down in response to the wave, thereby producing a reflected transverse wave 66 propagating to the left, as shown in FIG. 10.

Consequently, while the original longitudinal wave whose leading edge is represented by contour line 63 continues to propagate outwardly as a cylindrical wave, a new longitudinal wave 67 in the air whose leading edge is represented by constant pressure contour line 68 is created by the reflected transverse 66, and will interfere with longitudinal waves in the air produced by new transverse waves in the panel propagating to the right. As explained above, this can produce standing waves, or “modes” at various frequencies and other distortions in the sound waves produced by the panel.

To solve this problem, or at least greatly reduce its effect, reflections from the right hand edge are essentially eliminated, or at least greatly attenuated. This is done by providing the panel with a virtual infinite boundary. Two specific mechanisms are shown herein to accomplish this result, though it is to be understood that the scope of the broadest claims is not intended to be limited by the disclosure of these two mechanisms.

One mechanism for attenuating, preferably essentially eliminating, reflections from the boundary is to provide a dampening mechanism that absorbs the arriving wave energy so that it cannot produce a reflected wave. In FIG. 11, this is represented by a dashpot 70 that absorbs the arriving wave energy.

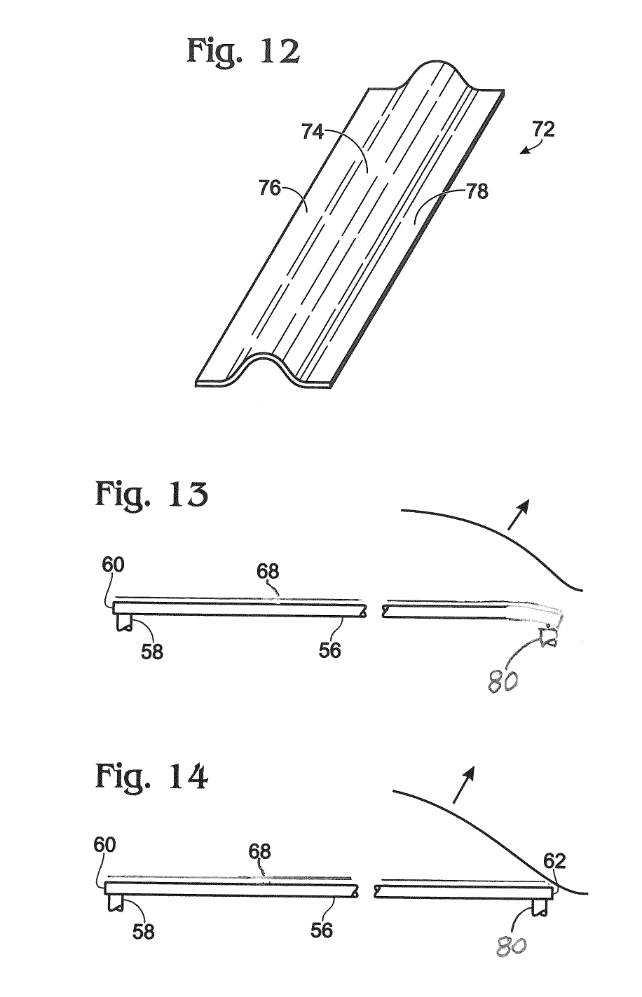

A physically realizable such damping mechanism is shown in FIG. 12. It comprises a resilient member 72 that fits over the edge of the panel and is held in place by a rigid frame to be described with respect to FIG. 10. Preferably the resilient member has a half-cylinder section 74 which fits snugly over the right edge of the panel, and flanges 76 and 78 on opposite sides of the half-cylinder section that enable the frame to hold the resilient member in place. Preferably the resilient member 72 has the same acoustic impedance as the panel so that at the interface there is essentially complete transfer of energy from the right edge 62 of the plate to the resilient member, and sufficient compressibility to absorb all of that energy. Under those conditions, essentially no energy is transferred back to the panel and the arriving wave is essentially fully damped. It is as though the edge of the panel extends to infinity.

An alternative, more versatile mechanism for attenuating, preferably essentially eliminating, reflections from a boundary of panel 56 is to provide the panel with one or more motors 80 disposed at the attenuating edge that are driven by an inverse signal that cancels the arriving wave and absorbs its energy. This is illustrated in FIGS. 13 and 14. When a transverse wave 64 arrives at the right hand edge 62 of the panel 56, it would ordinarily cause the edge to be displaced up, then down so as to initiate a reflection wave as shown in FIG. 13. However, in this case, a properly timed signal is sent to the motor 80 that, in the absence of an arriving wave 64, would displace the edge downwardly and then upwardly, as shown in FIG. 13. What actually happens in this case is that because a signal is provided that is essentially identical in shape but inverse in polarity, the motor resists upward displacement of the edge without actually pulling the edge downwardly and thereby cancels out the arriving signal, as shown in FIG. 14. Provided that the signal to motor 80 has exactly the right shape, amplitude and timing, the arriving wave energy is absorbed and produces a net energy flow into the motor drive circuit. As will be discussed below, under some circumstances the signal at motor 80 actually supply wave energy to the edge at which it is located to produce waves that propagate away from that edge, but that are not reflections of an arriving wave.

Various mechanical properties of the panel 56 produce three characteristics that will affect the shape, amplitude and timing of arrival of a wave that propagates from one edge, e.g., the left-hand edge, or boundary, 60 to another edge, e.g., the right-hand edge, or boundary 62. These characteristics are the amount by which a transverse wave is attenuated by the panel as a function of frequency (the amplitude frequency response or just “frequency response”), the speed of sound in the medium at a given frequency (“phase velocity”), and the rate of change of the phase velocity with frequency (“dispersion”).

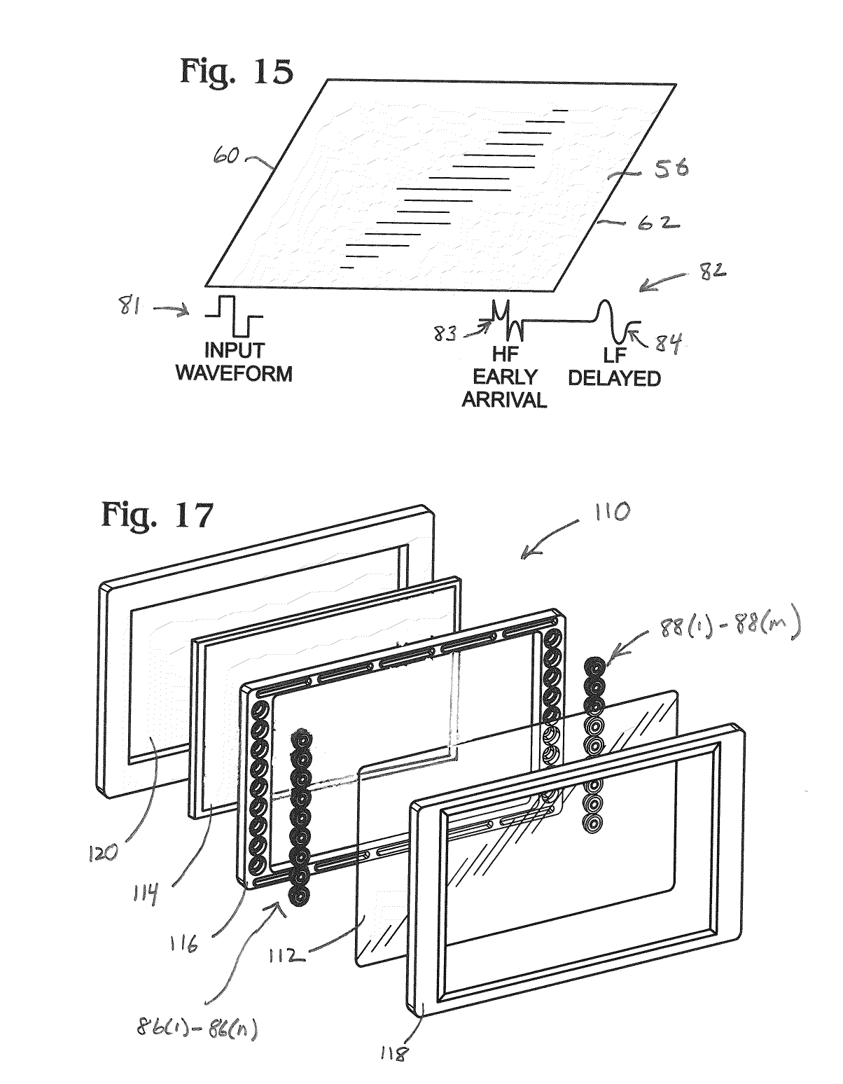

The effect of these three characteristics is illustrated in FIG. 15, where the left-hand edge of the panel has been displaced by a (theoretical) square wave 81. A square wave may be decomposed into the sum of a plurality of sine wave components having different frequencies. As the wave energy caused by the square wave displacement propagates from the left-hand edge, or boundary, 60 of the plate 56 to the right-hand edge, or boundary 62 the sine wave components experience attenuation to different degrees and different phase velocities according to the aforementioned three characteristics, resulting a change in the shape, amplitude and arrival time of energy from the wave. This is illustrated at 82, where the attenuated high frequency components 84 arrive first, followed by the low frequency components 80, thereby altering the square wave shape.

Consequently, to cancel out a wave generated at the left hand edge with the motor 80, the signal applied to that motor must be generated taking into account the time it takes different frequency components of the wave to arrive at the right-hand edge, based upon the phase velocity and dispersion, and the attenuation of that wave based on the frequency response, and the signal cancellation signal must have sinusoidal components with delays and attenuation corresponding to the components of the arriving wave. It must also be inverted when applied to the cancellation motor 80.

There are at least two ways to generate the cancellation wave. One is to (1) determine the propagation characteristics of the panel, or other diaphragm, that is, frequency response, phase velocity and dispersion, based physical properties of the panel such as panel material density, flexibility and dimensions, then (2) construct a digital or analog electrical, electro-mechanical acoustical, model of the propagation of the panel, (3) apply to that model the same electrical signal applied to the motor, or motors, at the left-hand edge of the panel, (4) invert the electrical output of the model, and (5) apply the inverted electrical output of the model to the motor, or motors, at the right-hand edge of the panel.

Another way is to measure the transfer function of the panel and motors. That is, to measure the complex electrical signal output (phase and amplitude) of the cancellation motor, or motors, in response to the complex electrical signal applied to the wave generation motor, or motors, and compute the inverse transfer function. A digital or analog electrical, or an electro-mechanical acoustical device, having the same inverse transfer function is then used to generate the cancellation signal by applying the same signal to that inverse transfer function device as is applied to the to the wave generation motors and the output of the device is applied to the cancellation motors.

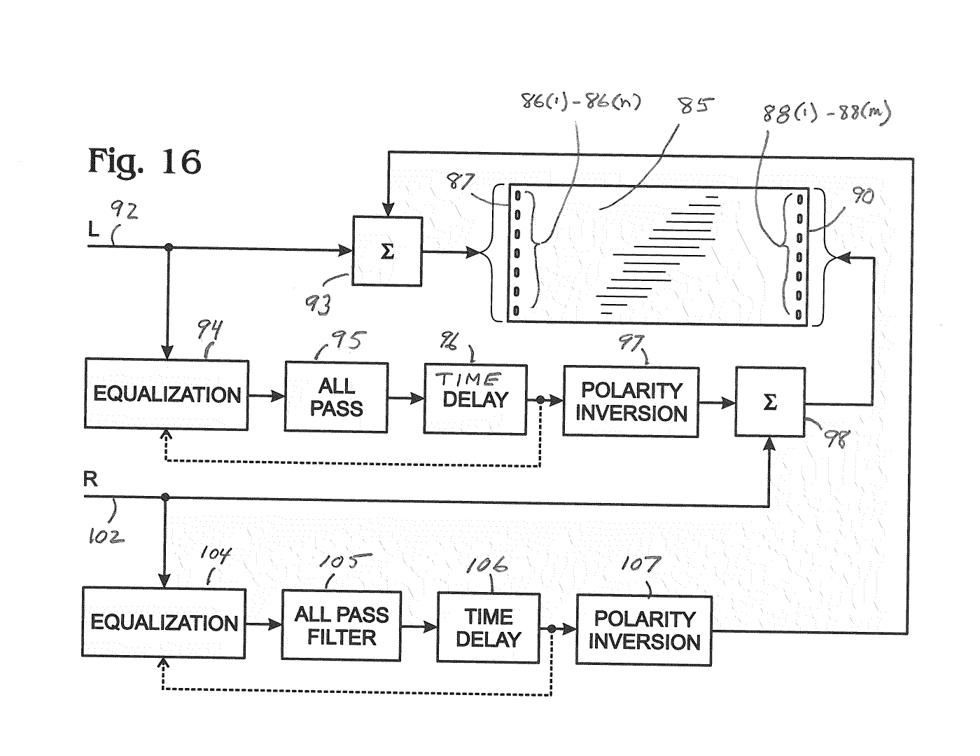

These principles are illustrated by the embodiment of a flat panel stereo loudspeaker shown in FIG. 16. In this case a panel 85 has a first plurality of motors 86(1)-86(n) distributed along the left-hand edge 87 and a second panel of motors 88(1)-88(m) distributed along the right-hand edge, or boundary, 90. Ordinarily m=n, but that does not necessarily need to be so. The motors could be of various types, including traditional moving coil loudspeaker motors, piezoelectric devices, electrostatic devices or other electrical-to-mechanical transducers. One particularly desirable linear motor is described below. While the sets of motors 86(1)-86(n) and 88(1)-88(m) at each edge of the panel 85 in FIG. 9 would ordinarily be driven in phase, respectively, that would not necessarily be so in general.

In this embodiment a left channel audio signal is applied at input 92, which leads to the left-hand motors 86(1)-86(n) through a signal summing circuit 93, whose purpose is explained hereafter. Input 92 is also connected to the input of an equalization (“EQ”) circuit 94, whose output is connected to the input of an all-pass (“AP”) circuit 95, whose output is connected to a time delay (“TD”) circuit 96, whose output is connected a polarity inversion (“PI”) circuit 97 to the motors at the right-hand edge 90 of the panel 85 through second summing circuit 98.

Referring back to the discussion above regarding how to produce a linear wave that propagates from the left-hand edge 86 to the right hand-edge 90 without producing reflections at the right hand edge, the equalization circuit 94, all-pass circuit 95, time delay circuit 97 and polarity inversion circuit 98 produce the cancellation signal to be applied to the motors at the right-hand edge 90 of the panel 85. That is, the equalization circuit applies the frequency response of the panel to the input circuit so that the cancellation signal applied to the motors 88(1)-88(m) at the right-hand edge of the panel reflect the frequency spectrum of the acoustic wave that arrives at the right-hand edge. The all-pass circuit 95 applies the dispersion characteristic of the panel so that the cancellation signal reflects the frequency-dependent delay of the acoustic wave when it arrives at the right-hand edge of the panel. The time delay circuit 96 applies the excess delay phase velocity characteristic of the panel to the cancellation signal to reflect the propagation time of the acoustic signal from the left-hand edge 87 to the right hand edge 90. Then the polarity inversion circuit 97 inverts the signal that is applied to the motors 88(1)-88(m) at the right hand edge of the panel so that those motors will resist movement of the right hand edge in response to the arriving acoustic wave and thereby substantially prevent reflections.

If this embodiment were only used to reproduce one channel of a stereo audio system neither the remaining circuits shown in FIG. 16 nor summing circuits 93 and 98 would be necessary. As described so far, the panel would produce a cylindrical longitudinal wave for a single audio channel with substantially no resonant modes or intermodulation distortion from waves reflected back from the right-hand edge 90 of the panel 85. Alternatively, in the case of a single audio channel, the right-hand edge can be dampened by a passive device as explained above.

However, it is desirable to be able to reproduce both channels of a stereo audio system with a single panel. To that end, the embodiment of FIG. 16 includes a right-channel audio input 102 which is applied through summer 98 to the motors 88(1)-88(m) at the right hand edge 90 of the panel to generate a transverse acoustic wave in the panel 85 that propagates from right to left. To cancel reflections of the right edge an acoustic wave from the left edge of the panel 85 is also provided with an (EQ) circuit 104, (AP) circuit 105, (TD) circuit 106 and (PI) circuit 107, which function like the same type of circuits applied to the left-hand signal and produce a cancellation signal applied through summer circuit 93 to the motors 86(1)-86(n) at the left-hand edge of the panel 85. In accordance with the principal of linear superposition, both the left-hand audio channel and the right hand audio channel are reproduced by the same panel 85, while reflections on the opposite edges are substantially attenuated or essentially cancelled.

Alternatively, the equalization, all-pass, delay and polarity inversion circuits may be replaced by a single circuit or device that implements the inverse transfer function of the panel based on a measured actual transfer function, as discussed above.

An example flat panel loudspeaker 110 for use with a video display is shown in FIG. 17. This product includes a flat acoustic diaphragm panel 112 made of a transparent material, such as glass, or polycarbonate or acrylic, placed in front of a video display panel 114 so that the display can be viewed through the loudspeaker panel. A frame 116 supports the panel 112 and left- and right-hand drive motors 86(1)-86(n) and 88(1)-88(m), respectively. A front bezel 118 and a back display frame 120 are also provided.

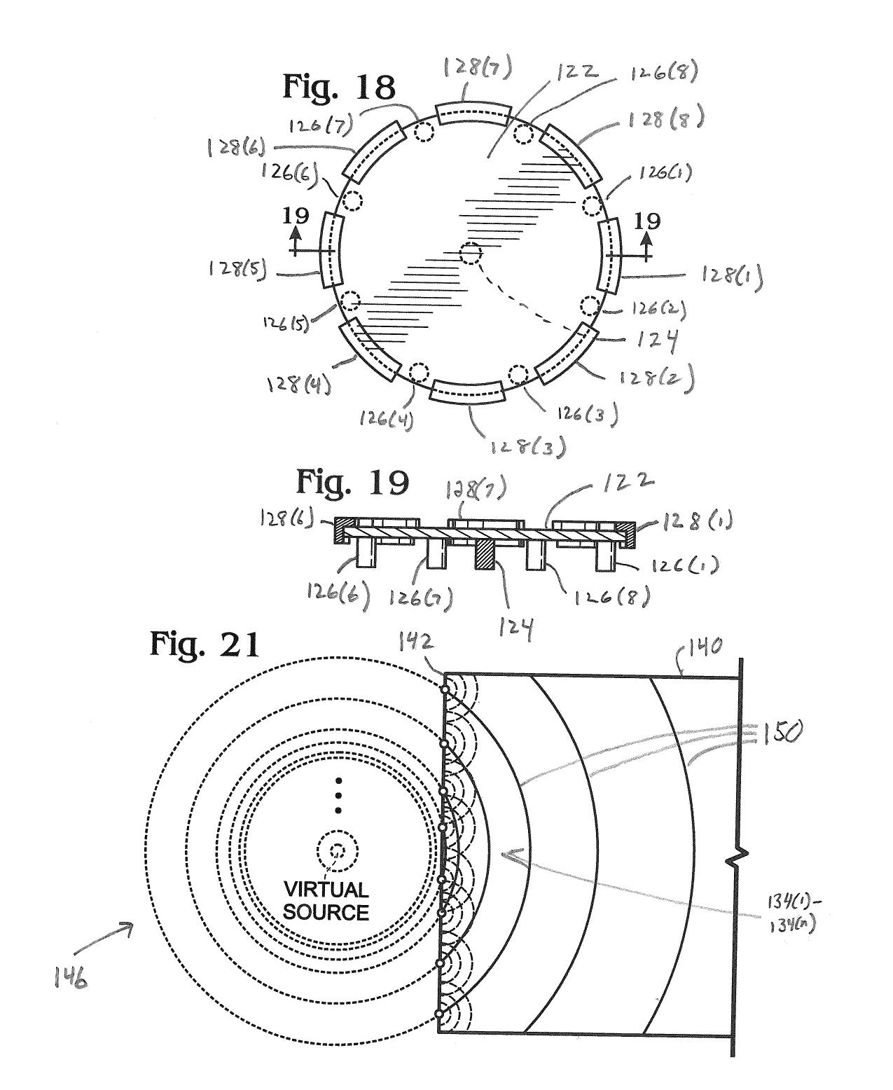

Alternatively, a quiescently flat acoustic transducer using these principles could be circular, as shown in FIGS. 18 and 19. Referring to FIG. 18, an example of an embodiment of such a transducer comprises a quiescently flat diaphragm 122, a wave generation motor 124 coupled to the diaphragm at the center thereof, a plurality of wave cancellation motors 126(1)-126(8) distributed around and coupled to the periphery of the diaphragm, and a plurality of damping members 128(1)-128(8) coupled to the periphery between the wave cancellation motors, thereby enabling the attenuation of transverse waves arriving from the center of the diaphragm by active or passive means. A cross section of this embodiment is shown in FIG. 19. It is to be understood that either damping members, or wave cancellation motors, or both as shown in FIGS. 18 and 19, may be used, and the number of damping members or cancellation motors may vary for particular design purposes.

In the simplest case, a radially propagating transverse circular acoustic wave is produced at the center of the diaphragm by the motor 124, and is attenuated by damping elements at the periphery of the diaphragm. In a more versatile case, wave cancellation motors, or a combination of damping elements and wave cancellation motors may be used for better effect on the full audio spectrum. In a yet more versatile case, all the motors may be used both for wave generation and wave cancellation, similarly to what is described hereafter with respect to a rectangular diaphragm to produce desired virtual point sources.

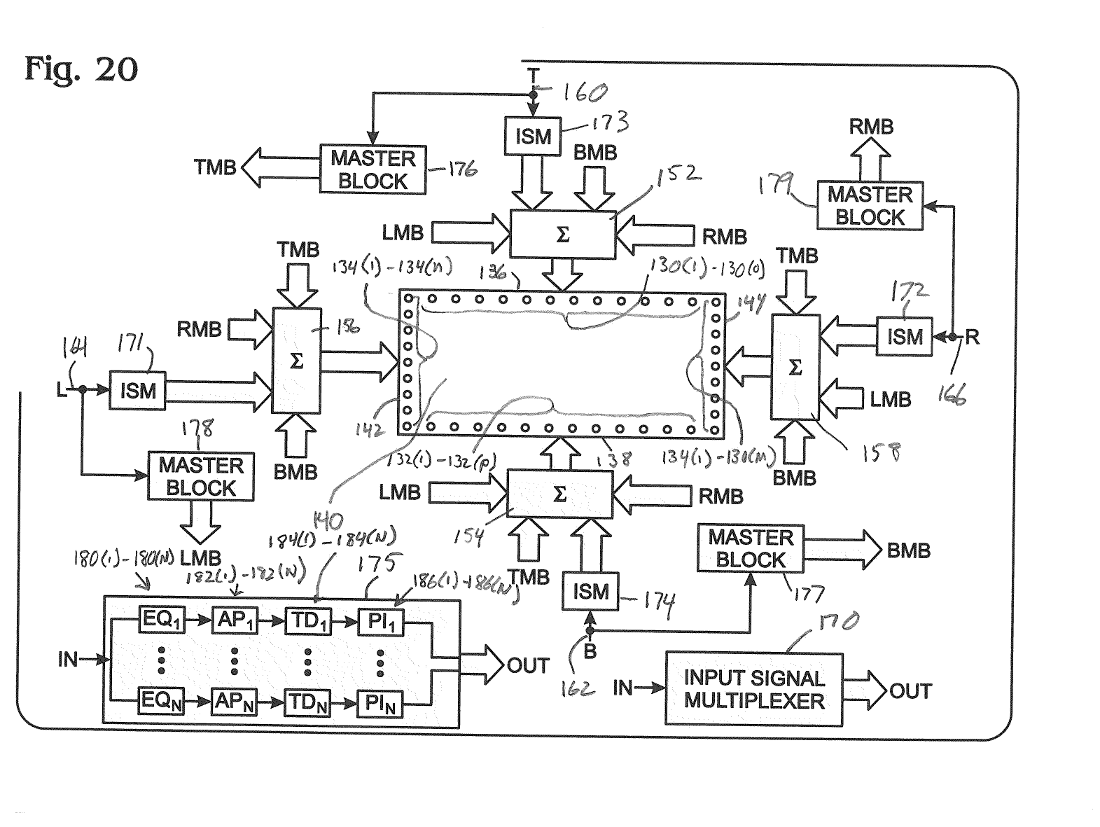

Generally, the principles disclosed herein may be used to produce multiple cylindrical, point or other shape wavefronts from real or virtual locations. A system for doing so is shown in FIG. 20, where respective pluralities of combination wave generation and wave attenuation motors 130(1)-130(o), 132(1)-132(p), 134(1)-134(n) and 134(1)-130(m) are disposed at the top 136 and bottom 138 edges of a rectangular acoustic flat panel 140, as well as at the left 142 and right 144 edges of the panel. In this case, each of the motors is separately driven so that each may act as an independent amplitude and phase source.

Consider the task of producing a virtual point source 146 of sound located outside the panel 140, specifically to the left of left edge 142, as shown in FIG. 12. If such a point source existed, it would produce spherical longitudinal waves propagating in the air, other acoustic medium, in which it is disposed. If the panel 140 had infinite lateral dimensions then, in order to produce spherical longitudinal waves in the medium, the point source would need to produce circular transverse waves in the panel. The panel cannot have infinite lateral dimensions and in this case the point source would be outside the panel, but does not actually exist. However, a virtual point source can be perceived if semicircular transverse waves 150 can be produced by motors 134(i)-134(n) in the panel 140, as they will produce transverse semispherical waves propagating in the medium as though they came from the virtual point source 146.

To produce other than linear transverse waves in the panel 140, the combination wave generation and wave attenuation motors along each edge generally must be individually controllable so as to act like point sources producing circular transverse waves having respectively selected amplitudes and phases such that when they interfere with one another, the resulting wave shapes will have the desired characteristics. In addition, in accordance with the principle of superposition, they must absorb energy from transverse waves arriving at the edges so that reflections are not generated and the panel is effectively infinite in lateral dimension.

For example, in the case of the virtual point source of FIG. 21 the left edge motors 134(1)-134(n) must be driven with related, but different delays so that in accordance with Huygen's principle, when the transverse waves they generate interfere they will collectively produce the semicircular transverse waves 150 seemingly emanating from virtual point source 146. At the same time, as the ends of those semicircular waves meet the top and bottom panel edges 136 and 138, respectively, the respective motors 130(1)-130(o) and 132(1)-132(p) at those edges must be driven so as to cancel arriving transverse waves to prevent reflections. Likewise, the motors 134(1)-134(m) at the right hand edge 144 must be driven to cancel arriving waves. An independent mirror image of the foregoing can be superimposed starting from the right hand edge 144 so as to produce a second virtual point source to the right of the panel so as to provide a stereo loudspeaker have virtual point sources to the left and to the right of the panel 140. In principle, any desired pattern of transverse panel waves that can be produced by linear superposition, and corresponding longitudinal waves thereby produced in the medium, can be generated by the motors distributed along the edges of the panel.

Returning to FIG. 20, to enable superposition of waves generated by point sources along all of the edges of the panel 140 and to provide the panel with effectively infinite lateral dimensions, each edge has a corresponding summing circuit, that is, top edge summing circuit 152, bottom edge summing circuit 154, left edge summing circuit 156 and right edge summing circuit 158. Each input, that is, top input 160, bottom input 162, left input 164 and right input 166, is applied to its respective summing circuit through an input signal multiplexer (“ISM”) 170, that is, left ISM 171, right ISM 172, top ISM 173 and bottom ISM 174, and to a corresponding master block circuit (“MSB”) 175, that is, top MSB 176, bottom MSB 177, left MSB 178 and right MSB 179. The inputs ISMs and MSBs produce multiple signals, one for each motor. The ISB's are adapted to determine the phase and amplitude signals that should be applied to each respective motor to generate the desired wave pattern on the panel.

As shown at 175, each master circuit includes a plurality of equalization sub-circuits 180(1)-180(N), a corresponding plurality of all-pass sub-circuits 182(1)-182(N), a corresponding plurality of delay sub-circuits 184(1)-184(N), and a corresponding plurality of invertor sub-circuits 186(1)-186(N) in series as explained with respect to FIG. 16, each such series of sub-circuits within a master block circuit corresponding to a particular motor input. The output of each master circuit for a given input is applied to the summing circuit corresponding to each of the other inputs. Likewise, the output of each ISM for a given input is applied to the summing circuit corresponding to each of the other inputs. The ISMs enable the generation of types of transverse waves other than linear waves, for example a circular wave for the virtual point source discussed above. Thus, the system shown in FIG. 20 is a four-edge generalization of the system of FIG. 16, and operates in essentially the same way but with respect to more inputs. It should be recognized that a panel could be made with more sides, respective pluralities of motors on each side, and a corresponding set of summing circuits and master blocks to achieve more complex transverse wave patterns.

b. Linear Transducer Motor

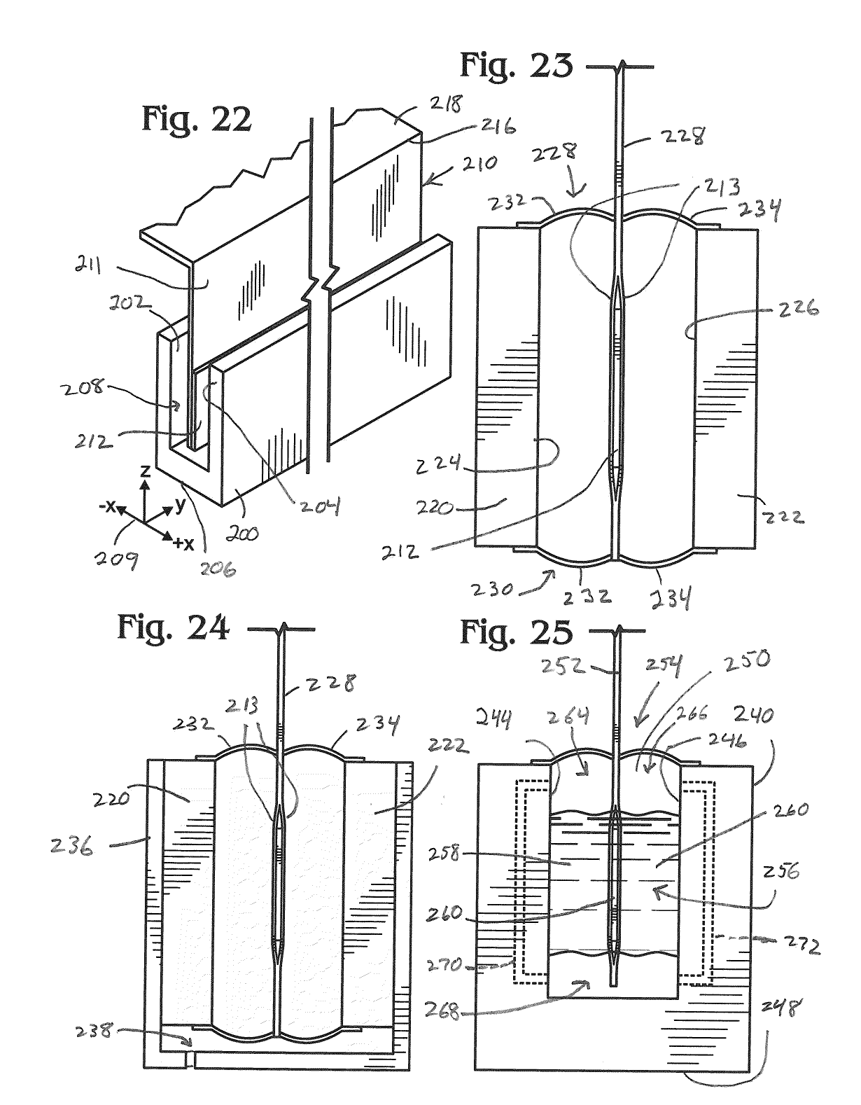

Various embodiments of a linear transducer motor that is particularly suitable for use with a stereo flat panel loudspeaker of the type shown in FIGS. 22-25 above are shown in FIGS. 22, 23, 24 and 26. This is because in that type of loudspeaker the goal is to produce linear transverse waves originating respectively from both the left and right edges of the panel, and concomitant approximately cylindrical longitudinal waves in the air. However, it is to be understood that the linear transducer disclosed herein may have application to other types of flat panel acoustic transducers and other devices as well.

Turning to FIG. 22, a first embodiment of a linear motor according to the inventive concepts comprises an elongate U-shaped magnet 200 having a north pole 202, a south pole 204, and an interconnecting portion 206 forming an elongate, fixed gap 208 between the north and south poles. For explanatory purposes, the lateral dimension across the gap of the magnet will be referred to as the X axis of a Cartesian coordinate system 209, the elongate dimension of the magnet will be referred to as the Y axis of the coordinate system, and the Z axis of the coordinate system runs through the center of the gap between the north pole 202 and south pole 204 of the magnet. The motor also comprises a linear armature 210 that is relatively thin in the dimension of the X axis, elongate in the dimension of the Y axis and disposed in the gap between the two poles such that the armature can move in and out of the gap in the dimension of the Z axis. Essentially, the armature is a single turn “coil”, which may consist of single conductor sandwiched between two flat and stiff bodies, or the armature may comprises a non-magnetic relatively flat, thin and rigid body member 211 and an elongate, electrically-conductive strip of material 212 disposed on one each side of the elongate body member. The material may be gold, copper, aluminum or some other appropriate conductor. In this embodiment the armature is connected to the edge 216 of a flat panel speaker diaphragm 218, as described and explained in Part (a) above, which holds the armature between the poles of the magnet 200.

When a current flows through the conductive strip 212, the magnetic field thereby produced interacts with the fixed magnetic field of magnet 200 to produce a force along the entire length of the armature 210 tending to push it out of or pull it into the gap 208. This in turn displaces the edge 216 of the speaker diaphragm 218, producing a transverse wave in the in the diaphragm originating at the edge 216. It should be understood that such a motor will be of relatively low impedance, and require a high current, low voltage amplifier.

FIG. 23 shows a second embodiment of a linear motor having unconnected magnets 220 and 222, the north pole of magnet 220 being at the right side 224 of the magnet and the south pole of magnet 222 being at the left side 226 of the magnet, with the south and north poles respectively located on the opposite sides of the magnets. In this case an armature 228 is also disposed between the north pole of one magnet and the south pole of the other magnet, not necessarily connected to a speaker diaphragm. Also in this case the conductive metal strip 212 is sandwiched between two pieces of non-magnetic relatively flat, thin and rigid material 213 to form the armature. The armature is supported by an upper suspension device 228 and a lower suspension device 230, each of which is connected between the armature and the two magnets, to center the armature and keep ambient air pressure from leaking into the system. The magnets may be held in position by any appropriate mechanism that need not, but could, be a magnet flux conduction material.

Each suspension device has a left flexible, curved suspension member 232 attached between the left side of the armature and the right side of the magnet 220, and a right flexible, curved suspension member 234 attached between the left side of the armature and the right side of the magnet 220. The suspension members in the upper suspension device are preferably convex upwardly, while in the lower suspension device the suspension members are preferable convex downwardly so as two be mirror images of one another and to keep unwanted matter from getting caught in the suspension members. However, it is to be understood that one or both pairs of the suspension members maybe curved in the opposite direction, or stretchable and not curved at all.

A further embodiment of a motor according to the inventive principles of this disclosure is shown in FIG. 24. This is like the embodiment of FIG. 23, except that the magnets 220 and 222 are held in place by a ferromagnetic frame 236. In this case, multiple spaced apertures 238 are formed along the Y-axis length of the frame to equalize the air pressure both above and below the suspension devices.

Yet another, fourth embodiment of a motor according to the principles of this disclosure is shown in FIG. 25. Like the embodiment of FIG. 22, this embodiment comprises an elongate U-shaped magnet 240 having a north pole 244, a south pole 246, and an interconnecting portion 248 forming an elongate, fixed gap 250 along the Y-axis between the north and south poles. The same Cartesian coordinate system used in FIG. 22 is used here. This further embodiment also comprises a linear armature 252 like that used in the embodiments of FIGS. 22-24. This embodiment further comprises an upper armature suspension device 254 as used in the embodiments of FIGS. 23 and 24. However, this embodiment employs a ferrofluid 256 to levitate the conductive strip in the center of the magnetic circuit, maintain the lateral position of the armature in the gap between the north and south poles of the magnet 240, cool the system and allow for much closer tolerances in the gap with increases efficiency.

The ferrofluid preferably comprises microscopic ferromagnetic particles that collectively behave like a fluid, but will aggregate together under the influence of a magnetic field so as to assume a collective shape that minimizes potential energy. An example of a suitable ferrofluid is described in Athanas U.S. Pat. No. 5,335,287, the entire contents of which are hereby incorporated by reference. Consequently, the ferrofluid forms symmetric portions 258 and 260 on opposite sides of the armature 252 substantially midway between the top and bottom of the gap, adjacent the respective conductive strip 260, thereby holding the armature in the center of the gap while it moves in the Z axis dimension in response to current flowing through the conductive strip 260. To ensure that the pressure in the chambers 264 and 266 formed above the ferrofluid portions 256 and below the suspension device 254 is equal to the pressure in the chamber 268 formed below the ferrofluid and within the walls of the magnet, two pressure equalizing passageways 270 and 272 are formed in the magnet between the north-side upper chamber 256 and lower chamber 268, and between the south-side upper chamber 266 and lower chamber 268, respectively.

The conductive strip in the motor embodiments of FIGS. 22-25 would ordinarily have a low resistance, on the order of 1 ohm, and be used with a low output-impedance, low-voltage, high-current drive circuit, as would be understood by a person skilled in the art.

It is to be understood that variations of the features of embodiments shown in FIGS. 22-25 may be used to form other embodiments without departing from the transducer motor concepts discussed in this disclosure. It is also to be understood that the linear motor disclosed herein may be used in applications other than a loudspeaker or other acoustic transducer without departing from those inventive concepts.

The terms and expressions which have been employed in the foregoing specification are used therein as terms of description and not of limitation, and there is no intention, in the use of such terms and expressions, to exclude equivalents of the features shown and described or portions thereof, it being recognized that the scope of the invention is defined and limited only by the claims that follow.

1. An acoustic transducer, comprising:
a diaphragm having at least one boundary;
at least one wave generator coupled to the diaphragm at a corresponding location on the diaphragm to displace the diaphragm and thereby produce a transverse wave in the diaphragm that propagates away from that location toward said at least one boundary; and
at least one attenuator coupled to the diaphragm at a corresponding location on said at least one boundary of the diaphragm to substantially attenuate the transverse wave at that location, thereby substantially preventing the production of a reflected transverse wave from that boundary location,
such that when the transducer is disposed in an acoustic medium and the wave generator displaces the diaphragm, the transverse wave produced in the diaphragm produces an acoustic longitudinal wave in the medium propagating away from the diaphragm with substantially attenuated distortion from diaphragm transverse waves reflected from that boundary location.

2. The transducer of claim 1, wherein the at least one attenuator is a passive transverse wave damping mechanism.

3. The transducer of claim 1, wherein the damping mechanism comprises a diaphragm suspension member that is compressible in the dimension perpendicular to the diaphragm and has mechanical impedance that substantially matches the mechanical impedance of the diaphragm.

4. The transducer of claim 1, wherein the at least one attenuator comprises at least one wave generator coupled to the diaphragm to displace the diaphragm so as to substantially cancel a transverse wave arriving at the attenuator.

5. The transducer of claim 1, wherein the diaphragm has four boundaries substantially forming the sides of a rectangle, said at least one wave generator being disposed at a first boundary of the rectangle and said at least one attenuator being disposed at a second boundary opposite the first boundary.

6. The transducer of claim 5, wherein said at least one wave generator comprises a plurality of wave generation motors distributed along the first boundary coupled to the diaphragm to displace the diaphragm so as to generate a transverse wave in the diaphragm that propagates away from the location of the motor.

7. The transducer of claim 6, wherein said at least one attenuator comprises a diaphragm suspension member that is compressible in the dimension perpendicular to the diaphragm and has a mechanical impedance that substantially matches the mechanical impedance of the diaphragm.

8. The transducer of claim 6, wherein said at least one attenuator comprises a plurality of attenuation motors distributed along the second boundary and coupled to the diaphragm to displace the diaphragm so as to substantially cancel a portion of a transverse wave arriving at the attenuation actuator.

9. The transducer of claim 8, wherein one or more of the wave generation or wave attenuation motors comprises an electrical signal to mechanical motion converter adapted to displace a boundary of the diaphragm in a direction perpendicular to the face of the diaphragm.

10. The transducer of claim wherein one or more of the wave generation or wave attenuation motors comprises an electrical signal to mechanical motion converter adapted to displace a boundary of the diaphragm in a direction parallel to the face of the diaphragm.

11. The transducer of claim 8, further comprising an electronic signal processor having an audio input to receive an audio electrical signal, a plurality of outputs connected to the wave generation motors and a plurality of outputs connected to the attenuation motors, the signal processor being adapted to cause wave generation motors to displace the diaphragm so as to produce a transverse acoustic wave representing an audio signal applied to the audio input and to cause the wave attenuation motors to displace the diaphragm so as to substantially cancel portions of a transverse wave arriving at respective attenuation actuators.

12. The transducer of claim 11, wherein the signal processor is adapted to cause the diaphragm to produce a cylindrical longitudinal acoustical wave substantially as though the diaphragm had no reflective boundaries and having an apparent line source at a selected location.

13. The transducer of claim 11, wherein the wave generation and wave attenuation motors are selected from one or more of a moving coil, electrostatic, electromagnetic or piezoelectric electrical signal to mechanical motion conversion device.

14. The transducer of claim 6, wherein the diaphragm is quiescently substantially flat and further comprising a plurality of motors distributed along a third boundary, substantially perpendicular to the first boundary and the second boundary, and coupled to the diaphragm to displace the diaphragm so as to generate a transverse wave in the diaphragm that propagates away from the location of the motor, and a plurality of motors distributed along the fourth, remaining boundary and coupled to the diaphragm to displace the diaphragm so as to substantially cancel portions of a transverse wave arriving at respective attenuation motors.

15. The transducer of claim 14, wherein the wave generation and wave attenuation motors are selected from one or more of a moving coil, electrostatic, electromagnetic or piezoelectric electro-to-mechanical transducer.

16. The transducer of claim 11, wherein the signal processor is adapted to cause the diaphragm to produce a spherical longitudinal acoustical wave substantially as though the diaphragm had no reflective boundaries and having an apparent point source at a selected location.

17. The transducer of claim 1 further comprising a frame and a suspension system for supporting the diaphragm, said at least one wave generator and said at least one attenuator.

18. The transducer of claim 1, wherein the diaphragm comprises a material that is transparent to visible light or other electromagnetic radiation.

19. The acoustic transducer of claim 1, wherein the at least one wave generation motor is a linear motor comprising
an elongate first magnet having a north and south poles extending along the elongate dimension of the first magnet;
an elongate second elongate magnet having a north and south poles extending along the elongate dimension of the second magnet;
a support member for holding the first magnet in relation to the second magnet so that their elongate dimensions are substantially parallel, opposite poles of the first magnet and the second magnet face one another, respectively, and a gap exists there between; and
a substantially planar armature disposed in the gap between the first magnet and the second magnet, the armature having a driving portion adjacent one edge thereof and a flat, electrically-conductive element having an elongate dimension extending substantially parallel to the elongate axes of the magnets, the armature being connected to a boundary of the diaphragm,
such that when an electric current is caused to flow in the elongate dimension of the electrically-conductive element, a force is exerted on the planar armature in a translational direction parallel to a surface of the armature and perpendicular to the elongate axes of the magnets so as to displace the diaphragm.

20. The acoustic transducer of claim 19, wherein the at least one attenuator is also a linear motor as set forth in claim 19.

21. A method for driving an acoustic transducer having a diaphragm with at least one boundary, comprising:
displacing the diaphragm at a selected location onto the diaphragm, thereby producing a transverse wave in the diaphragm that propagates away from that location toward said at least one boundary; and
substantially attenuate the transverse wave at least at one location on the boundary to substantially prevent the production of a reflected transverse wave from that boundary location,
such that when the transducer is disposed in an acoustic medium and the wave generator displaces the diaphragm, the transverse wave produced in the diaphragm produces an acoustic longitudinal wave in the medium propagating away from the diaphragm with substantially attenuated distortion due to an interfering diaphragm transverse wave reflected from that boundary location.

22. A motor for producing planar motion, comprising:
an elongate first magnet having a north and south poles extending along the elongate dimension of the first magnet;
an elongate second elongate magnet having a north and south poles extending along the elongate dimension of the second magnet;
a support member for holding the first magnet in relation to the second magnet so that their elongate dimensions are substantially parallel, opposite poles of the first magnet and the second magnet face one another, respectively, and a gap exists there between; and
a substantially planar armature disposed in the gap between the first magnet and the second magnet, the armature having a driving portion adjacent one edge thereof and a flat, electrically-conductive element having an elongate dimension extending substantially parallel to the elongate axes of the magnets,
such that when an electric current is caused to flow in the elongate dimension of the electrically-conductive element, a force is exerted on the planar armature in a translational direction parallel to a surface of the armature and perpendicular to the elongate axes of the magnets.

23. The motor of claim 19, further comprising a magnetic conductor member disposed between the first magnet and the second magnet adjacent respective first elongate edges thereof so as to produce a high flux-density magnetic circuit between the two magnets, the planar armature extending between the second two opposite elongate edges of the respective magnets.

24. The motor of claim 20, further comprising at least one suspension member disposed between the two magnets and the armature to restrain movement of the armature primarily to said translational direction.

25. The motor of claim 21, comprising at least two such suspension members separated from one another in said translational direction.

26. The motor of claim 23, further comprising a vent between the magnetic conductor member and the closer of the suspension members for equalizing the air pressure on the exterior of both said suspension members.

27. The motor of claim 21, further comprising a ferrofluid disposed in the between the magnetic conductor member and said at least one suspension member to levitate the planar armature, a first air cavity being formed between the ferrofluid and said at least one suspension member, a second air channel being formed between the magnetic conductor member and the ferrofluid, and an air channel between formed between the first cavity and the second cavity to equalize the pressure in both cavities.

28. The motor of claim 20, further comprising at least one suspension member disposed between the two magnets and the armature to restrain movement of the armature primarily to said translational direction.

29. The motor of claim 25, comprising at least two such suspension members separated from one another in said translational direction.

30. The motor of claim 20, wherein the planar armature is coupled to a diaphragm for moving an acoustic fluid to produce acoustical waves in the fluid in response to a time varying current through the electrically-conductive element.

31. The motor of claim 27, wherein the diaphragm is quiescently substantially planar and oriented perpendicularly to the planar armature.

32. The motor claim 28, wherein the acoustical fluid is air and the varying of the current is in the audio frequency band so that the combination acts as a loudspeaker.

33. The motor of claim 30, wherein the diaphragm is quiescently substantially planar and coupled to the planar armature at an edge of the diaphragm and an edge of the armature, movement of the planar diaphragm in its planar dimension being at least partially constrained at a location separate from the armature so as to produce transverse waves in the diaphragm.

34. The motor of claim 30, wherein the acoustical fluid is air and the varying of the current is in the audio frequency so that the combination acts as a loudspeaker.

35. A method for producing motion in a plane, comprising:
providing U-shaped having two sides separated by an elongate gap, having a north pole on one side the gap and a south pole on the other side of the gap;
supporting an elongate substantially flat, rigid and movable armature within the gap;
providing an elongate electrically-conductive strip disposed on the armature extending in the elongate dimension of the gap; and
causing an electric current to flow in the strip so as to produce a magnetic field and concomitant force on the armature tending to move it in or out of the gap.
